(19) United States
(12) Patent Application Publication
(10) Pub. No.: US 2009/0159380 A1
(43) Pub. Date: Jun. 25, 2009

(54) Brake Shoe and Method of Manufacturing the Same

(76) Inventors: Masaaki Kobayashi, Aichi (JP); Hiroyuki Fujikawa, Aichi (JP); Yuji Komori, Aichi (JP)

Correspondence Address: BUCHANAN, INGERSOLL & ROONEY PC, POST OFFICE BOX 1404, ALEXANDRIA, VA, 22313-1404, US

(21) Appl. No.: 12/093,260

(22) PCT Filed: Nov. 27, 2003
(86) PCT No.: PCT/JP2006/323589

§ 371 Date: May 9, 2008

(30) Foreign Application Priority Data
Nov. 30, 2005 (JP) 2005-346560

(51) Int. Cl. F16D 69/00; B23P 15/18

(52) U.S. Cl. 188/251 A; 29/233

(57) ABSTRACT

An object is to provide a brake shoe which can be manufactured by a method comprising a reduced number of manufacturing steps, and such a method. A brake shoe 1 is manufactured by cutting a sheet blank formed by extrusion or calender sheeting into strips having a predetermined length, laying the strips on the shoe body 2, pressing and bonding the strips to the shoe body 2 and hardening the strips. The lining 3 is formed with tapered surfaces 4 at both ends thereof for facilitating release of the lining from a die. The lining 3 preferably contains as a binder a rubber that turns into ebonite when subjected vulcanization.

### TECHNICAL FIELD

This invention relates to a brake shoe which is high in productivity and of high cost performance, and a method of manufacturing such a brake shoe.

### BACKGROUND ART

A lining which forms, in cooperation with a shoe body, a brake shoe used e.g. in a vehicle drum brake comprises a substrate, lubricant, friction adjusting agent, binder and filler. As the binder, phenolic resin is typically used. Such a lining is formed separately by dry-mixing these substances, subjecting the mixture to performing and heat forming to obtain an arcuate member, and subjecting the arcuate member to heat treatment for hardening and to finish grinding. The lining is pressed against the shoe body through adhesive to bond it to the shoe body. The lining is then again subjected to heat treatment to complete the brake shoe.

With this ordinary method, the lining alone is formed by pressing and subjected to heat treatment. Then, the lining is pressed against and bonded to the shoe body, and is again subjected to heat treatment. Such a method therefore requires large amounts of pressure and heat as well as a large number of manufacturing steps, and thus tends to be costly.

Brake shoes and methods of manufacturing brake shoes are disclosed e.g. in the below-identified patent publications 1 and 2.

Patent publication 1 discloses a method of manufacturing a strip of friction member having a uniform thickness by kneading a composition containing a water-soluble thickener and water until the composition becomes clayish, and extruding the clayish composition from an extruder. With this method, after the above-described steps, it is necessary to cut the strip of friction member into plate-shaped blanks having a predetermined length, forming the thus cut blanks into curved plates, and bonding the curved plates to a weight. Since the steps of forming the plate-shaped blanks into curved plates and bonding the curved plates to the weight are carried out separately from each other, a larger number of steps are necessary.

On the other hand, Patent document 2 discloses a method comprising the steps of integrally forming a shoe body and a preformed lining with the preformed lining formed into a final shape simultaneously and also hardened simultaneously. With this method, since the lining is preformed before being bonded to the shoe body, an extra pressing step is necessary to preform the lining.

[Patent document 1] JP patent publication 2003-156090A

[Patent document 2] JP patent publication 3677235B

### DISCLOSURE OF THE INVENTION

### Object of the Invention

A larger number of manufacturing steps leads to increased necessary manpower and energy consumption, and thus increased cost. An object of the present invention is to provide a brake shoe which can be manufactured by a method comprising a smaller number of manufacturing steps, and such a method.

### Means to Achieve the Object

According to the present invention, a sheet blank formed by extrusion or calender sheeting is cut into strips having a predetermined length, the strips are laid on the shoe body, and the strips are pressed against and bonded to the shoe body as a lining and hardened. Thus, a brake shoe comprising the shoe body and the arcuate lining securely fixed to the shoe body is obtained. Because the lining of the brake shoe is shaped on the shoe body by a die, tapered surfaces are formed thereon at both ends thereof which facilitate release of the lining from the die.

Preferably, the lining is made of a composition containing a binder which is a rubber or primarily comprises a rubber.

The rubber as the binder is preferably one which is configured to turn into ebonite when subjected to vulcanization. By adding 20 to 40 parts by weight of sulfur to 100 parts by weight of the rubber, the rubber turns into ebonite when subjected to vulcanization. The rubber may be butadiene rubber (BR), styrene rubber (SBR), nitrile rubber (NBR) or isoprene rubber (IR). If not very high heat resistance is required, the rubber may be a diene rubber such as natural rubber (NR).

The lining may contain as binders a rubber which is configured to turn into ebonite when subjected to vulcanization, and a thermosetting resin such as phenolic resin. In this case, the content ratio of the rubber to the thermosetting resin should be within the range of 100:0 to 50:50, preferably within the range of 100:0 to 70:30. If the content of the resin is higher than the content of the rubber, the effect of the rubber will decrease to such an extent that the bond strength between the shoe body and the lining is insufficient.

From another aspect of the present invention, there is provided a method of manufacturing a brake shoe, the method comprising the steps of forming a sheet blank by extrusion or calender sheeting, cutting the sheet blank into strips of a predetermined length, laying the strips as a lining on an arcuate shoe body, pressing the lining with upper and lower dies, using the shoe body as another die, to arcuately bend the lining while forming tapered surface at both ends thereof for facilitating release of the lining from the upper die, and simultaneously bonding the lining to the outer periphery of the shoe body, and subjecting the arcuate lining to heat treatment. With this method, a brake shoe comprising the arcuate shoe body and the arcuate lining bonded to the outer periphery of the shoe body is obtained.

### ADVANTAGES OF THE INVENTION

The brake shoe according to the present invention is manufactured by the method according to the present invention, wherein the lining is formed by cutting a sheet blank formed by extrusion or calender sheeting into strips having a predetermined length, laying the strips on the shoe body, and pressing and bonding the strips to the shoe body before hardening the strips. Thus, it is not necessary to arcuately shape the lining beforehand. Thus, it is possible to reduce the number of shaping steps as well as the number of steps of grinding the lining, thereby improving productivity. Also, a reduction in the number of manufacturing steps leads to a reduction in the necessary manpower and energy consumption.

Since the sheet blank to be formed into the lining is bonded to the arcuate outer periphery of the shoe body without being arcuately shaped beforehand, the binder contained in the sheet blank is preferably a rubber or primarily comprises a rubber. By using a binder in the form of a rubber or a binder primarily comprising a rubber, it is possible to obtain a sheet blank having a uniform thickness and stable in physical properties by extrusion or calender sheeting. Also, because the sheet blank is sufficiently flexible before being hardened, it is possible to bond the sheet blank, after being cut into strips of a predetermined length, to the shoe body so as to extend along the arcuate outer periphery of the shoe body.

If an ordinary soft rubber is used as a binder, it may be difficult to ensure sufficient heat resistance and wear resistance. But by using a rubber which is configured to turn into ebonite when subjected to vulcanization, it is possible to ensure sufficient heat resistance and wear resistance required for the lining. Also, by turning into ebonite, the rubber according to the present invention allows the lining to reliably produce required braking force without producing squeals or other noise.

### BRIEF DESCRIPTION OF THE DRAWINGS

FIG. 1 is a side view of a brake shoe embodying the present invention;

FIG. 2 is a front view of the brake shoe of FIG. 1;

FIG. 3 shows the steps of the method according to the present invention for manufacturing the brake shoe;

FIG. 4 shows the steps of a conventional method for manufacturing a brake shoe; and

FIG. 5 schematically shows a calender sheeting step.

### DESCRIPTION OF NUMERALS

1. Brake shoe

2. Shoe body

2a. Rim

2b. Web

3. Lining

3A. Sheet blank for the lining

4. Tapered surface for facilitating release from the die

5. Mixer

6. Extruder

7. Cutter

8, 8-1, 8-2. Press

9. Furnace

10, 10-1, 10-2. Grinder

11. Baking machine

12. Calender roll machine

12a-12c. Rolls

### BEST MODE FOR EMBODYING THE INVENTION

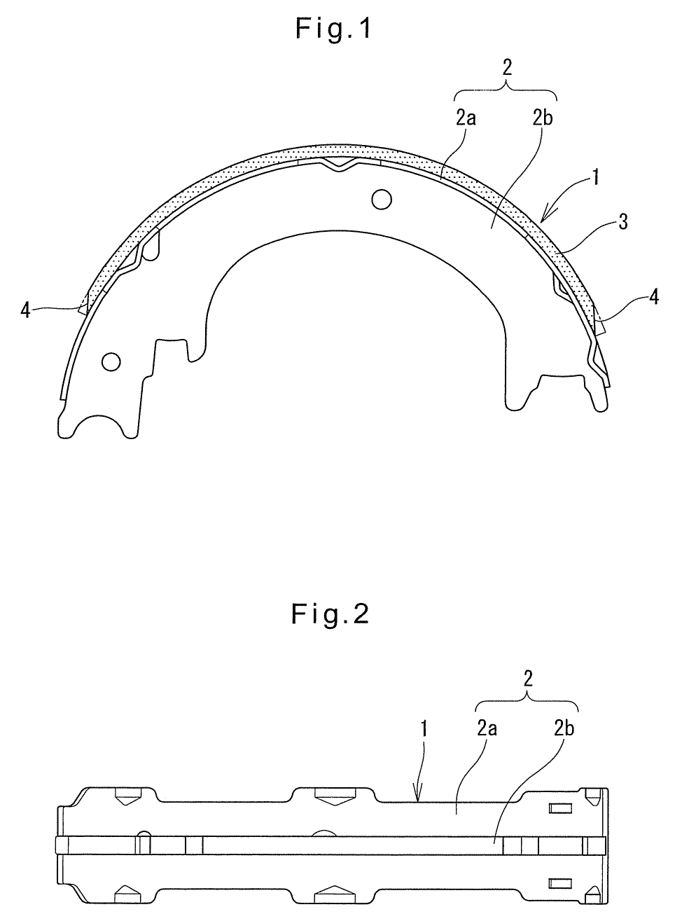

Now description is made of a brake shoe embodying the present invention and a method of manufacturing such a brake shoe embodying the present invention. As shown in FIGS. 1 and 2, the brake shoe 1 of the embodiment is one for use in a drum brake, and comprises a shoe body 2 and an arcuate lining 3 bonded to the outer periphery of the shoe body 2. The shoe body 2 comprises an arcuately bent rim 2a, and a web 2b joined to the inner periphery of the rim 2a. The lining 3 is bonded to the outer periphery of the rim 2a.

The lining 3 is made of a composition which is a mixture of a substrate, lubricant, friction adjusting agent, filler and binder. The substrate, lubricant, friction adjusting agent and filler may be those used in compositions for ordinary friction members. In such compositions for ordinary friction members, fibrous substrates such as metallic fibers, synthetic resin fibers and inorganic fibers are used as their substrates. Also, typically, their lubricants are graphite and their friction adjusting agent and filler are metallic oxides, metallic salts (barium sulfate) and organic powders (such as cashew dust). The lining 3 according to the present invention may be made of similar materials.

The binder, however, is not an ordinary one but comprises a rubber or primarily a rubber. Such a rubber may be butadiene rubber (BR), styrene rubber (SBR), nitrile rubber (NBR), isoprene rubber (IR), or a diene rubber such as natural rubber (NR).

To 100 parts by weight of the rubber, 20 to 40 parts by weight of sulfur is added. By adding a large amount of sulfur, the rubber turns into ebonite and hardens when subjected to vulcanization. This increases the heat resistance and friction resistance of the rubber to levels well above the levels required for the lining. The rubber is added by a known rubber kneading method using e.g. an open roll, Banbury mixer, pressurized kneader or extruder.

The binder may further comprise a thermosetting resin such as phenolic resin. In this case, in order for the rubber to sufficiently reveal its expected functions, the content ratio of the rubber to the thermosetting resin should be within the range of 100:0 to 50:50, preferably within the range of 100:0 to 70:30.

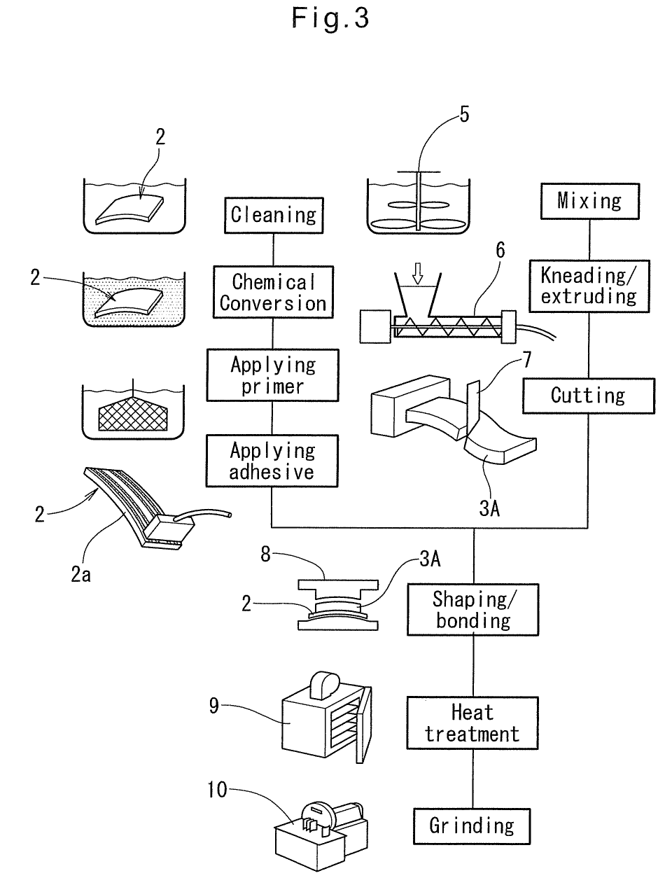

The method of manufacturing this brake shoe is now described. As shown in FIG. 3, as preparatory steps, the shoe body 2 is washed, subjected to chemical conversion treatment, and after applying a primer, air-dried. (These steps are the same as those in conventional methods for manufacturing brake shoes.)

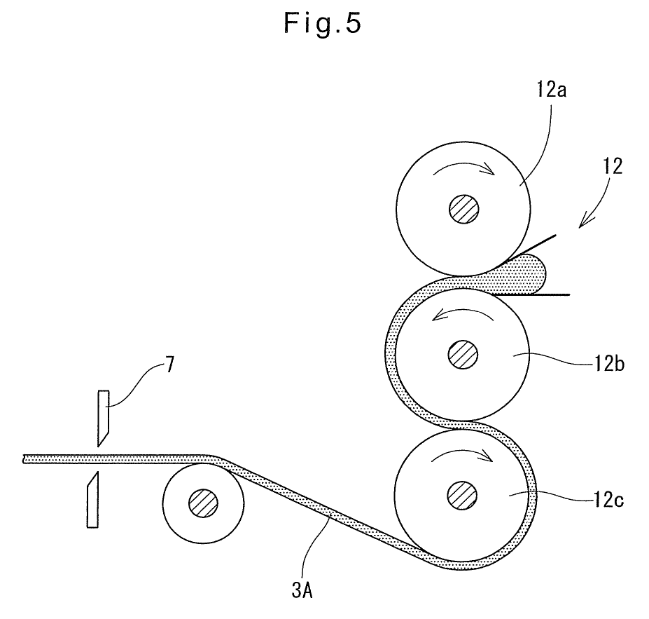

The composition to be formed into the lining is prepared by mixing raw materials in e.g. a mixer 5. The composition is kneaded in and extruded from an extruder 6 or subjected to calender sheeting to form a sheet blank 3A having a uniform thickness. The calender sheeting is performed using a calender roll machine 12 shown in FIG. 5. The calender roll machine 12 shown includes three rolls 12a to 12c that are arranged one over another. The composition is formed into the sheet blank 3A by being passed between the rolls 12a and 12b and then between the rolls 12b and 12c.

The thus formed sheet blank 3A is cut into strips of a predetermined length by a cutter 7. Otherwise, the strips may be formed by blanking the sheet blank. In this case, the portion of the blank that remains after blanking is reused for extrusion or calender sheeting. The strips are fed to a shaping/bonding station.

In the shaping/bonding station, adhesive is applied to the outer periphery of the rim 2a of the shoe body 2 which has been treated in the preparatory steps, and the shoe body 2 is set between upper and lower dies of a press 8. In this state, the strips of the sheet blank 3A are laid on the outer periphery of the rim 2a of the shoe body 2, and the shoe body 2 and the strips of the sheet blank 3A are pressed with the upper and lower dies of the press 8 while heating. During this process, the shoe body 2 serves as a die for the strips of the sheet blank 3A, allowing the strips to be bent along and closely pressed against the outer periphery of the rim 2a. Since the shoe body and the strips of the sheet blank 3A are heated when pressed, they are simultaneously bonded together.

The thus pressed and bonded shoe body and the strips of the sheet blank 3A are placed in a furnace 9 and subjected to heat treatment to harden the lining. Then, as a last step, the lining 3 is ground by a grinder 10 to complete the brake shoe according to the present invention.

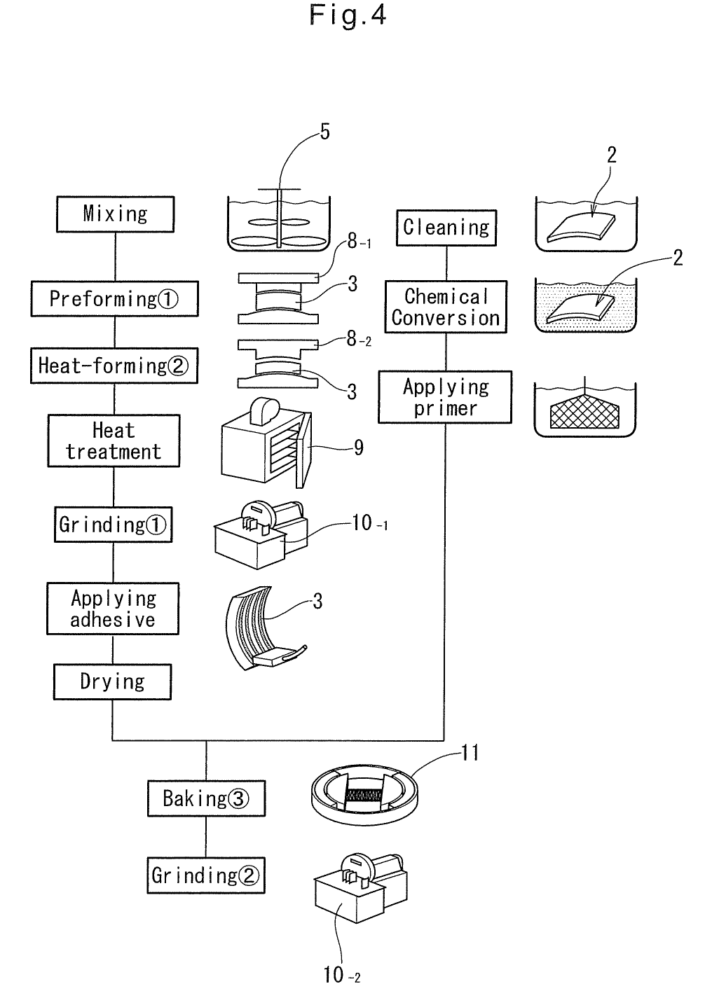

For comparison, FIG. 4 shows a conventional method for manufacturing a brake shoe. The preparatory steps for the shoe body in this method are identical to the preparatory steps in the method according to the invention. But there is a clear difference in the manufacturing steps of the lining 3. In the conventional method, three pressing steps are necessary, including performing the lining 3 with a press 8-1, heat-pressing the lining 3 with a press 8-2, and baking the lining 3 to the shoe body with a baking machine 11. Further, three grinding steps are necessary, including grinding the inner and outer surfaces of the lining alone with a grinder 10-1, and final finishing with a grinder 10-2.

In contrast, according to the method of the present invention, because the lining is bonded to the shoe body simultaneously when the lining is bent, it is possible to reduce the number of pressing steps by one compared to the conventional method. It is also possible to reduce the number of grinding steps by one because it is unnecessary to grind the lining before being bonded to the shoe body.

On the lining 3 of the brake shoe according to the present invention, which is manufactured by the method according to the present invention, tapered surfaces 4 are formed at both ends thereof to facilitate release from the die. It is well-known in the art that by chamfering the edges of the lining at both ends thereof, it is possible to effectively suppress squeaking of the brake shoe. Like such chamfers, the tapered surfaces 4 for facilitating release from the die also serve to effectively suppress squeaking of the brake shoe.

1. A brake shoe comprising an arcuate shoe body and an arcuate lining bonded to the outer periphery of said shoe body, characterized in that said lining is formed by cutting a sheet blank formed by extrusion or calender sheeting into strips having a predetermined length, laying said strips on said shoe body, pressing and bonding said strips to said shoe body and hardening said strips, said lining containing rubber as a binder which is capable of being turned into ebonite by vulcanization and actually turned into ebonite, said lining being formed with tapered surfaces at both ends thereof for facilitating release of said lining from a die.

2. (canceled)

3. The brake shoe of claim 1 wherein said lining contains, besides said rubber, a thermosetting resin as an additional binder.

4. The brake shoe of claim 1 wherein 20 to 40 parts by weight of sulfur is added to 100 parts by weight of said rubber.

5. A method of manufacturing a brake shoe comprising an arcuate shoe body and an arcuate lining bonded to the outer periphery of the shoe body, said method comprising the steps of forming a sheet blank by extrusion or calender sheeting, said sheet blank containing rubber as a binder which is capable of being turned into ebonite by vulcanization, cutting the sheet blank into strips of a predetermined length, laying the strips as the lining on the arcuate shoe body, pressing the lining with upper and lower dies, using the shoe body as another die, to arcuately bend the lining while forming tapered surface at both ends thereof for facilitating release of the lining from the upper die, and simultaneously bonding the lining to the outer periphery of the shoe body, and subjecting the arcuate lining to heat treatment.

6. The brake shoe of claim 3 wherein 20 to 40 parts by weight of sulfur is added to 100 parts by weight of said rubber.
